(19) United States
(12) Patent Application Publication
(10) Pub. No.: US 2008/0105726 A1
(43) Pub. Date: May 8, 2008

(54) Vertical feed hand stapler

(75) Inventor: Thomas A. Batho, South Haven, MN (US)

Correspondence Address: BRIGGS AND MORGAN P.A., 2200 IDS CENTER, 80 SOUTH 8TH ST, MINNEAPOLIS, MN, 55402, US

(73) Assignee: Malco Products, Inc., Annandale, MN (US)

(21) Appl. No.: 11/583,460

(22) Filed: Oct. 18, 2006

(51) Int. Cl. B25C 5/06

(52) U.S. Cl. 227/120

(57) ABSTRACT

A vertical hand stapler has a staple holder, a staple feeder with a housing that receives a staple from the staple holder; a hand operated plunger reciprocating within the staple feeder housing to eject a staple from the staple feeder and permit another staple to enter the feeder; and a deflecting retainer holding a staple in place within the staple feeder housing that is deflected by the plunger to permit a staple to be ejected from the staple feeder.

### BACKGROUND OF THE INVENTION

The present invention relates to a vertical feed hand stapler, and in particular to such a device with an improvement to prevent staple jams.

Vertical hand staplers can be used in multiple applications. One such application is, without excluding others, stapling heated water tubes to underlying foam insulation in the construction of a heated floor for a bathroom.

Such vertical hand staplers generally feed plastic staples in packs in which the staples are loosely connected. As a staple is fed into the mechanism, there is a possibility that it will break loose from the pack and remain in the mechanism, so that a subsequently fed staple will be jammed, or that the loose staple will be so tightly retained in the mechanism that the next-fed staple will cause the first staple to break.

There is a need for an improvement to a vertical hand stapler that addresses the above problems.

### SUMMARY OF THE INVENTION

A vertical hand stapler, comprising:

(a) a staple holder;

(b) a staple feeder having a housing and receiving a staple from the staple holder;

(c) a hand-operated plunger reciprocating within the staple feeder housing to eject a staple from the staple feeder and permit another staple to enter the staple feeder; and

(d) a deflecting retainer holding a staple in place within the staple feeder housing and being deflected by the plunger to permit a staple to be ejected from the staple feeder.

A principle object and advantage of the present invention is that it prevents a staple from being broken by an adjustment screw being too tight.

Another principle object and advantage of the present invention is that it prevents a staple jam when a staple separates from the pack of staples.

Another principle object and advantage of the present invention is that it does not require adjustment by the operator either to prevent a staple from being broken or to prevent a separated staple from causing a staple jam.

Another principle object and advantage of the present invention is that the deflecting retainer is easily manufactured by cutting a slot in the staple feeder housing.

Another principle object and advantage of the invention is that it prevents lost time on a job site do either to broken staples or to a staple jam.

### BRIEF DESCRIPTION OF DRAWINGS

FIG. 1 is a perspective view of the present invention.

FIG. 2 is a cross-section of the staple feeder portion of the prior art.

FIG. 2A shows one result of a staple jam in FIG. 2.

FIG. 3 shows another result of a staple jam in FIG. 2.

FIG. 4 is a cross-section of the staple feeder portion of the present invention taken at approximately the lines 4 of FIG. 1.

FIG. 5 is similar to FIG. 4 showing the result of feeding another staple, preventing a staple jam, in the present invention.

FIG. 6 is an exploded view of the vertical hand stapler of the present invention.

### DETAILED DESCRIPTION OF THE INVENTION

The present invention is generally shown in the drawings as reference numeral 10.

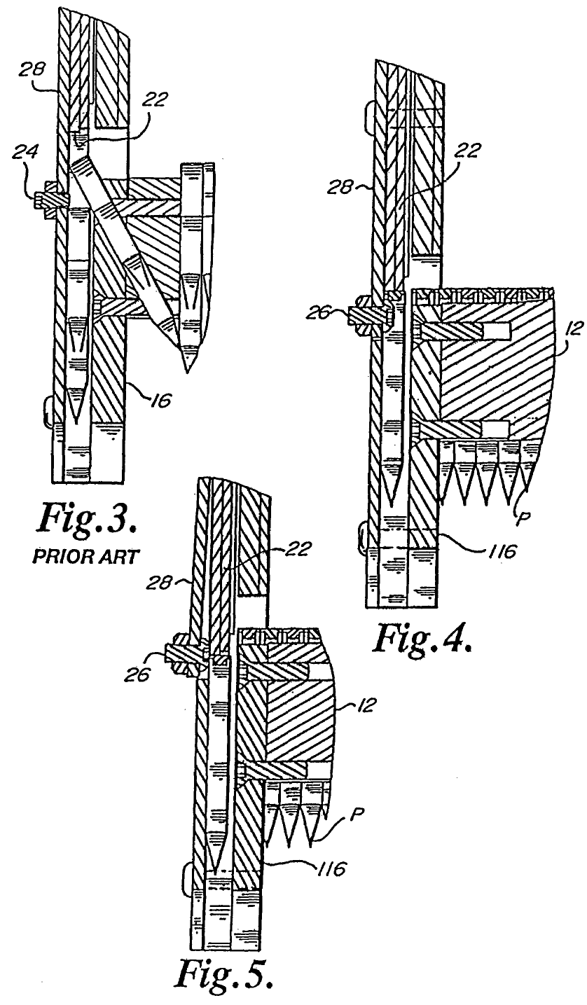

A vertical hand stapler 10 comprises a staple holder 12 upon which a pack P of staples S is slidingly engaged. Each staple S, as shown in FIG. 2A, is U-shaped, with two arms S1 and S2 connected by a bridge S3 (FIG. 2A shows a staple S that has been fractured by a staple jam of the prior art). The staples S in the pack are slid onto the staple holder 12 so that the first staple in the pack engages a staple feeder 16. The staple feeder 16 of previous devices holds the staple S in place by an adjustment screw 24 (see FIGS. 2 and 3). A rod 18 biased by a spring 20 prevents the staple feeding plunger 22 from being pressed against the fed staple until the operator presses down on the handle 23

In a normal situation, the staples are loosely connected in a pack P at the bridge S3. Staples are normally fed into the staple feeder 16 by gravity. As the first staple in the pack P is fed, the bridge to the next staple in the pack P remains intact until broken by the plunger 22.

In earlier devices, each staple within the staple feeder 16 is held in place by an adjusting screw 24 (FIGS. 2 and 3), which holds the staple at the bridge 23. This screw is normally factory set to prevent a single staple from falling out of the staple feeder 16. However, during operation, the screw may loosen, or the operator may tighten the screw too much.

As previously described, each staple enters the staple feeder connected to the rest of the staple pack. However, it is quite possible for a staple in the pack P to separate prematurely from the remaining staples in the pack by bridge being detached. The result depends on the position of the adjustment screw 24.

FIG. 2 shows the result of tightening the adjustment screw 24 too much. When the staple feeding plunger 22 is pressed against the separated staple, the staple is so tightly retained by the adjustment screw that the pressure of the plunger 22 against the adjustment screw 24 breaks the staple at the bridge S3, as shown in FIG. 2A. Until the adjustment screw 24 is backed out slightly, the stapler will continue to fracture the staples. This will happen even if a staple does not separate prematurely from the staple pack.

FIG. 3 shows the result when the operator has loosened the adjustment screw 24 too much. Now, if a staple separates from the pack P, it will not be held in place by the adjustment screw 24 and will have a tendency to fall out of the staple feeder 16. FIG. 3 shows that another staple may feed against the separated staple and be tilted up at an angle. When the operator presses the handle 22, the next staple, instead of being in line with the plunger 22, is pushed up by the plunger 22 against the separated staple at an angle as shown in FIG. 3. This causes a staple jam as the staple that is pushed up at an angle engages the next staple in line.

Thus, the problem in earlier staplers of this type is that the adjustment screw 24 does not hold a staple in place sufficiently to allow the staple to feed, or alternatively is so tight that the staple is fractured during feeding. It is necessary for the operator to experiment and make very fine adjustments to the adjustment screw 24, and even then the adjustment may not hold. This can be quite time consuming.

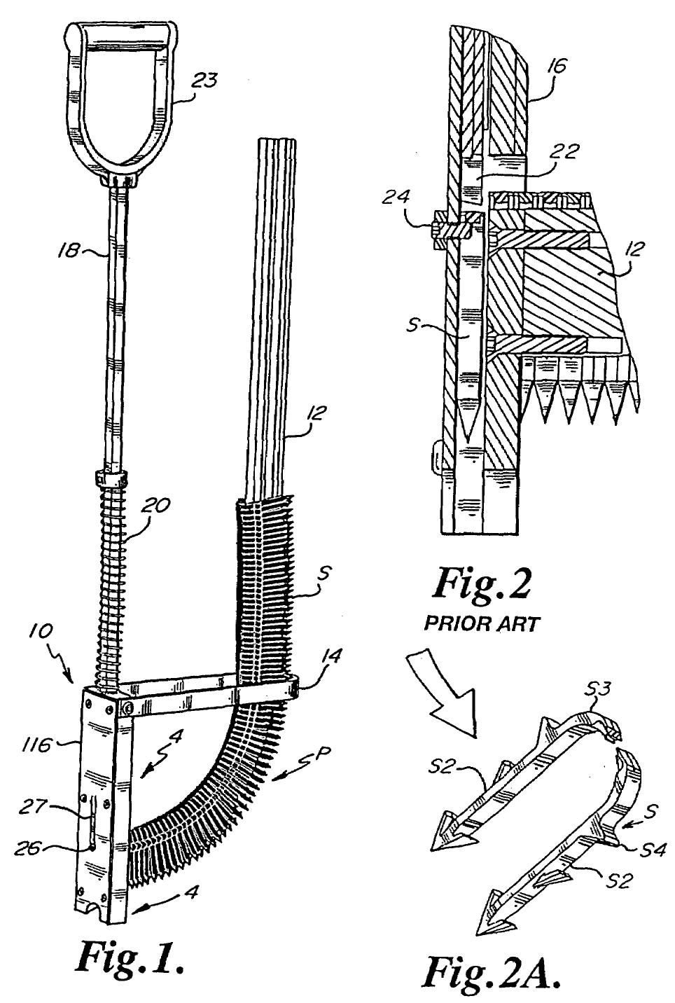

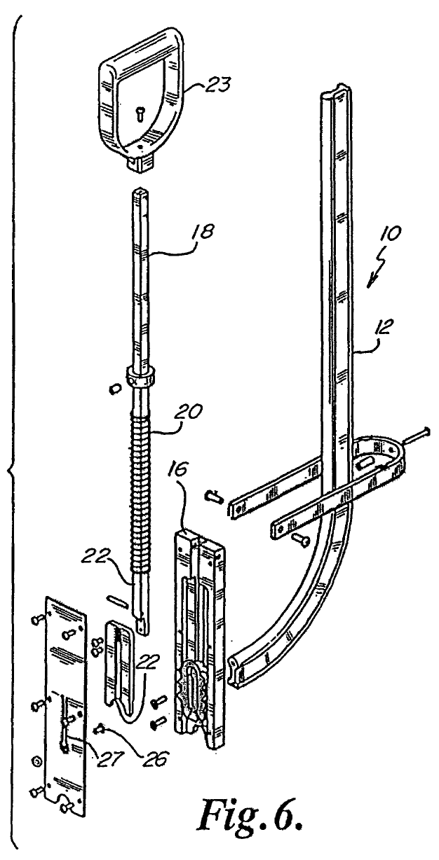

The present invention comprises a vertical hand stapler 10 with an improved staple feeder 116. The improvement comprises a deflecting retainer 26, operation of which is shown in FIGS. 4 and 5. As shown in FIGS. 1 and 6, in the preferred embodiment, a slot 27 is partially cut out from the housing of the staple feeder 116. The material remaining in the slot acts effectively as a spring 28, biasing the deflecting retainer 26 inwardly. The deflecting retainer 26 can be a screw or other fastener, but is preferably a button-head socket screw held in place by a nut at one extremity of the slot 27. The spring 28 may be separate from the housing of the staple feeder, and may be any type of spring that will bias the deflecting retainer 26 inwardly.

FIG. 4 shows the situation where a separated staple has fallen into the staple feeder 116. The deflecting retainer 26, biased by the spring 28 or similar mechanism, holds the separated staple in place. The plunger 22 is shown just touching the separated staple. Because the staple is held in place by the deflecting retainer 26, it cannot start to fall out of the staple feeder 116. It will not be ejected until the plunger 22 is pushed against it. Thus, when the next staple in the pack P is fed, it will not engage the separated staple as shown in FIG. 3, thus avoiding a staple jam.

In FIG. 5, the plunger 22 has pushed the staple past the deflecting retainer 26, which has been deflected away from the staple against the bias of the spring 28. Because of the deflection of the deflecting retainer 26, the staple will feed normally out of the staple feeder 116 without fracturing. As the plunger 22 is withdrawn by the operator, the next staple in the pack P will feed normally and will be held in place by the deflecting retainer 26 as it is biased against the next staple by the spring 28 as the plunger 22 moves off the deflecting retainer 26, as shown again in FIG. 4.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A vertical hand stapler, comprising:
(a) a staple holder;
(b) a staple feeder having a housing;
(c) the housing further comprising a front wall having an aperture receiving a staple from the staple holder, a pair of side walls, and a rear wall, the front wall, side walls, and rear wall forming a fully-enclosed staple-receiving space;
(d) a hand-operated plunger reciprocating within the staple feeder housing to eject a staple from the staple feeder and permit another staple to enter the staple feeder; and
(e) a spring comprising material partly cut from the housing along three sides and remaining attached to the housing on a fourth side and being biased against a staple; and
(f) a deflecting retainer attached to the spring and holding a staple in place within the staple feeder housing and being deflected by the plunger to permit a staple to be ejected from the staple feeder;
(g) wherein passage of the plunger over the deflecting retainer deflects the deflecting retainer away from the housing and wherein passage of the plunger off the deflecting retainer permits the deflecting retainer to return toward the housing.

2-4. (canceled)

5. In a vertical hand stapler having a staple holder, a staple feeder with a housing receiving staples from the staple holder, and a plunger reciprocating within the staple feeder housing, an improvement comprising a spring-biased deflecting retainer securely holding a staple within the staple feeder and being deflected by the plunger to eject the staple from the staple feeder, wherein the spring-biased deflecting retainer further comprises material partly cut from the housing in the path of the plunger and otherwise remaining connected to the housing, wherein passage of the plunger over the material deflects the material away from the housing and wherein passage of the plunger off the material permits the material to return towards the housing.

6. (canceled)
